(19) United States
(12) Patent Application Publication
(10) Pub. No.: US 2025/0053884 A1
(43) Pub. Date: Feb. 13, 2025

(54) ARTIFICIAL INTELLIGENCE-BASED SYSTEM FOR PERFORMING ONE OR MORE ACTIONS ASSOCIATED WITH PLANT MANAGEMENT AND METHOD THEREOF

(71) Applicant: Khushi Shah, Peoria, IL (US)

(72) Inventor: Khushi Shah, Peoria, IL (US)

(21) Appl. No.: 18/797,919

(22) Filed: Aug. 8, 2024

Related U.S. Application Data
(60) Provisional application No. 63/449,386, filed on Aug. 8, 2023.

(51) Int. Cl. G06N 20/20; G06N 20/10

(52) U.S. Cl. CPC G06N 20/20; G06N 20/10

(57) ABSTRACT

An artificial intelligence-based system for performing one or more actions associated with plant management and a method thereof are disclosed. The artificial intelligence-based system comprises one or more sensors and one or more servers. The artificial intelligence-based system is configured to obtain at least one of: sensor data, weather data, precipitation data, and agronomic variables data. The artificial intelligence-based system is configured with one or more computational models to determine at least one of: interpolate sensor data and extrapolate sensor data. The artificial intelligence-based system is configured to perform a comparative analysis between the obtained sensor data and pre-defined sensor data, based on at least one of the: weather data, precipitation data, agronomic variables data, interpolate sensor data and extrapolate sensor data, to generate one or more instructions for actuating one or more agrarian equipment for performing the one or more actions associated with plant management.

### CROSS REFERENCE TO RELATED APPLICATION(S)

This application claims the priority to and incorporates by reference the entire disclosure of U.S. provisional patent application bearing No. 63449386 filed on Aug. 8, 2023; titled “SMART IRRIGATION SYSTEM”.

### TECHNICAL FIELD

Embodiments of the present disclosure relate to agricultural technology, and more particularly relate to an artificial intelligence-based system and method for performing one or more actions associated with plant management.

### BACKGROUND

Agriculture has always been a critical sector for human survival, providing food, raw materials, and employment. However, traditional farming practices encounter numerous challenges, including unpredictable weather patterns, pest infestations, soil degradation, and inefficient resource utilization. Predominantly, the agriculture faces persistent challenges related to water management, cost inefficiencies, and sustainability concerns. Traditional plant management systems, reliant on schedule-based irrigation methods, invariably lead to water wastage and financial inefficiencies. Farmers typically rely on fixed schedules for irrigation, which are unable to align with actual crop water needs due to varying weather conditions and soil moisture levels. Consequently, the water is frequently over-applied, resulting in inefficiencies and unnecessary costs.

Moreover, the reliance on the schedule-based irrigation methods requires the farmers to be physically present to manually activate or adjust agrarian equipment. This manual intervention not only adds to labor costs but also limits the flexibility and responsiveness of plant management to real-time environmental conditions. Financially, the inefficiencies in water usage contribute to increased operational costs for the farmers, affecting their overall profitability. Additionally, excessive water application leads to environmental concerns, such as groundwater depletion and soil erosion, further highlighting a need for sustainable water management practices in the agriculture.

In recent years, technological advancements have brought about a concept of precision agriculture, which aims to optimize agricultural practices by using data-driven insights. Precision agriculture employs various sensors, satellite imagery, and Internet of Things (IoT) devices to monitor crop health, soil conditions, and environmental factors. One of the primary issues with current precision agriculture is the lack of integration and interoperability among different devices and platforms. The farmers often need to use multiple systems to gather and analyze data, which is cumbersome and time-consuming. Additionally, the data collected from various sensors and devices is not always processed in real-time, leading to delays in decision-making and implementation.

Another significant drawback is the limited use of advanced analytical techniques in current precision agriculture. While some systems utilize basic data analysis, they often lack the capability to perform complex predictive modeling and optimization. This results in less accurate recommendations and suboptimal resource allocation, negatively impacting crop yield and sustainability. Moreover, existing precision agriculture typically requires a prominent level of manual intervention. The farmers need to constantly monitor data, interpret results, and manually adjust equipment and practices. This not only increases the workload but also leaves room for human error. The lack of automation in current precision agriculture hinders their efficiency and effectiveness.

Furthermore, many precision agriculture systems are not designed to adapt to diverse agricultural environments and flora types. They often provide generalized recommendations that may not be suitable for specific conditions or crops, limiting their usefulness and applicability.

In the existing technology, an intelligent agriculture system is disclosed. The intelligent agriculture system comprises of pH, moisture, temperature, humidity, water flow, and ultrasonic sensors. Herein both open-air and underground sensors collect data and send it continuously to the controller. The controller checks those values; pulls data about rainfall occurrence from existing systems; and initiates the water management module by deciding to turn on/off the water supply by sprinkler/pipes. The intelligent agriculture system stores all data on the cloud; post cultivation, crop productivity is calculated and analyzed; machine learning algorithms are applied to predict the crop productivity in the future under similar climatic scenarios.

However, the existing intelligent agriculture system encounters several limitations. Firstly, the reliance on pre-set thresholds and periodic data updates may lead to suboptimal irrigation decisions, as the intelligent agriculture system does not dynamically adjust to real-time changes in environmental conditions or crop water requirements. while the intelligent agriculture system stores collected data on the cloud and employs the machine learning algorithms to forecast crop productivity based on historical data, it may not sufficiently leverage real-time sensor data for precise irrigation management. The intelligent agriculture system does not disclose any consideration of farm/field inclination data input by the user to control the smart irrigation system, which leads to usage of an additional number of sensors to collect the sensor data.

There are various technical problems with the plant management in the prior art. In the existing technology, the precision agriculture frequently relies on the schedule-based irrigation methods that operate on predefined timers or thresholds. Such precision agriculture methods do not adapt to real-time environmental changes, leading to inefficient water usage and increased operational costs. Moreover, the manual intervention is often required to adjust irrigation schedules based on observed conditions, which are labor-intensive and prone to human error. Additionally, existing systems lack integration with advanced sensor technologies and real-time data analytics. This limitation results in suboptimal decision-making regarding water application, nutrient management, and pest control. Furthermore, irrigation practices may not account for variations in the soil moisture levels across different zones within the field, thereby failing to maximize crop productivity while minimizing water consumption.

Therefore, there is a need for a system to address the aforementioned issues by enhancing plant management practices.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence-based system for performing one or more actions associated with plant management is disclosed. The one or more actions comprises at least one of: water management, nutrient application, pest control, weed management, growth monitoring, yield prediction, soil health assessment, crop rotation planning, harvesting scheduling, remote monitoring and diagnostics, and climate adaptation strategies.

In an embodiment, the artificial intelligence-based system comprises one or more sensors, one or more servers, and one or more agrarian equipment. The one or more sensors is operatively positioned in a field of plant, wherein the one or more sensors are configured to generate sensor data. The sensor data comprises at least one of: soil moisture data, soil pH levels, soil health data, soil composition data, soil temperature data, leaf wetness, micronutrient levels, disease detection data, plant canopy temperature, and root zone temperature.

In one embodiment, the one or more servers comprises one or more hardware processors and a memory unit. The memory unit is coupled to the one or more hardware processors, wherein the memory unit comprises a set of computer-readable instructions in form of a plurality of subsystems. The plurality of subsystems is configured to be executed by the one or more hardware processors. The plurality of subsystems comprises a data-obtaining subsystem, a hydrological modeling subsystem, a data analysis subsystem, and a plant management subsystem.

Yet another embodiment, the data-obtaining subsystem configured to obtain at least one of: a) the sensor data from the one or more sensors, the sensor data comprises at least one of: soil moisture data, soil pH levels, soil health data, soil composition data, soil temperature data, leaf wetness, micronutrient levels, disease detection data, plant canopy temperature, and root zone temperature, b) weather data, and precipitation data associated with one or more locations of the field of plant through at least one of: a user manual input, on-site weather sensors, satellite-based monitoring, Internet of Things (IoT) weather stations, weather application programming interfaces (APIs), weather forecast models, weather data integration platforms, and one or more communication device applications, c) agronomic variables data from one or more communication devices configured with the artificial intelligence-based system, through one or more user interfaces. The agronomic variables data comprises at least one of: flora-type data, growth stage data, and field characteristics data. The flora-type data comprises at least one of: crop types, plant species, and plant density. The growth stage data comprises at least one of a: seedling stage, vegetative stage, flowering stage, fruiting stage, and ripening stage. The field characteristics data comprises at least one of: soil types, soil compositions, gradient of a field inclinations, field sizes, and drainage characteristics.

In another embodiment, the hydrological modeling subsystem is configured with one or more computational models to determine at least one of: interpolate sensor data and extrapolate sensor data, between the one or more sensors based on at least one of: water evaporation rates and agronomic variables data of an associated location of the one or more locations of the field of plant. The one or more computational models utilized in the hydrological modeling subsystem is at least one of: one or more machine learning models and one or more analytical models.

In an embodiment, the data analysis subsystem is configured with the one or more computational models to perform a comparative analysis between the obtained sensor data and pre-defined sensor data stored in a database, based on at least one of the: weather data, precipitation data, agronomic variables data, and at least one of the: interpolate sensor data and extrapolate sensor data, to generate one or more instructions. The one or more instructions comprises at least one of: irrigation schedule data, water amount data, irrigation duration data, irrigation frequency data, zone-specific irrigation data, soil moisture target levels, notifying the micronutrient levels, one or more alerts for manual intervention, one or more fertilization schedule alerts, pest and disease control instructions, pruning schedules, optimal harvest times, crop rotation recommendations, drainage management instructions, one or more water quality monitoring alerts, remote system diagnostics, and one or more irrigation system maintenance alerts. The one or more computational models utilized in the data analysis subsystem is at least one of: one or more artificial intelligence models and the one or more machine learning models. The data analysis subsystem is configured to perform the one or more actions in real-time based on real-time feedback from at least one of the: sensor data, weather data, and precipitation data.

Yet an embodiment, the one or more computational models comprises at least one of the: one or more artificial intelligence models, one or more machine learning models, and one or more analytical models. The one or more artificial intelligence models is configured to analyze the pre-defined sensor data obtained in the database for updating required soil moisture levels for the diverse flora-type data in the database with respect to at least one of the: weather data, precipitation data, and agronomic variables data. The one or more artificial intelligence models comprises at least one of: artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), and fuzzy logic systems.

The one or more machine learning models is configured to analyze the sensor data to identify patterns of the soil moisture data and forecast the soil moisture levels for performing the one or more actions associated with the plant management based on diverse conditions. The one or more machine learning models comprises at least one of: linear regression, polynomial regression, the decision trees, random forests, the gradient boosting machines (GBM), the support vector machines (SVM), the K-nearest neighbors (KNN), the Bayesian networks, and clustering models.

The one or more analytical models is configured to determine at least one of the: interpolate sensor data and extrapolate sensor data for performing the one or more actions associated with the plant management based on the water evaporation rates. The one or more analytical models comprises at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, and water budget models.

In another embodiment, the plant management subsystem is configured to autonomously actuate the one or more agrarian equipment positioned in the one or more locations of the field of plant for performing the one or more actions associated with the plant management, based on the generated one or more instructions. The plant management subsystem is configured to autonomously actuate the one or more agrarian equipment through one or more agrarian control modules, for performing the one or more actions in the field of at least one of: entire plant, zone-specific within the plant, and pattern-specific within the plant. The one or more agrarian equipment comprises at least one of: one or more irrigation equipment, one or more soil preparation equipment, one or more planting equipment, one or more crop maintenance tools, one or more harvesting machinery, one or more transport equipment, one or more post-harvest equipment, and one or more pest control equipment.

Yet another embodiment, the artificial intelligence-based system comprises a manual override subsystem. The manual override subsystem is configured to perform the one or more actions through the user interface associated with the one or more communication devices. The artificial intelligence-based system is configured with a retrofitting control unit. The retrofitting control unit is configured to interface with one or more existing agrarian equipment by employing at least one of a: retrofitting controller, retrofitting adapter, programmable logic controllers (PLCs), electrically controlled valves, and modular sensor interfaces, via one or more communication networks, for performing the one or more actions.

In accordance with an embodiment of the present disclosure, an artificial intelligence-based method for performing the one or more actions associated with plant management is disclosed. In a first step, the artificial intelligence-based method includes generating, by one or more sensors, sensor data. In the next step, the artificial intelligence-based method includes obtaining, by the one or more servers, at least one of the: sensor data, weather data, precipitation data, and agronomic variables data. In the next step, the artificial intelligence-based method includes determining, by the one or more servers configured with one or more computational models, at least one of the: interpolate sensor data and extrapolate sensor data, between the one or more sensors based on at least one of the: water evaporation rates and agronomic variables data of an associated location of the one or more locations of the field of plant.

In the next step, the artificial intelligence-based method includes performing, by the one or more servers configured with the one or more computational models, the comparative analysis between the obtained sensor data and the pre-defined sensor data stored in the database, based on at least one of the: weather data, precipitation data, agronomic variables data, and at least one of the: interpolate sensor data and extrapolate sensor data to generate the one or more instructions. Further, in the next step, the artificial intelligence-based method includes actuating, by the one or more servers, the one or more agrarian equipment positioned in the one or more locations of the field of plant for performing the one or more actions associated with the plant management, based on the generated one or more instructions.

In accordance with an embodiment of the present disclosure, a non-transitory computer-readable storage medium having programmable instructions stored therein, that when executed by one or more servers, cause the one or more servers to: a) obtaining at least one of the: sensor data, weather data, precipitation data, and agronomic variables data, b) determining by using the one or more computational models at least one of the: interpolate sensor data and extrapolate sensor data, between the one or more sensors based on at least one of the: water evaporation rates and agronomic variables data of the associated location of the one or more locations of the field of plant, c) performing by using the one or more computational models the comparative analysis between the obtained sensor data and the pre-defined sensor data stored in the database, based on at least one of the: weather data, precipitation data, agronomic variables data, and at least one of the: interpolate sensor data and extrapolate sensor data to generate the one or more instructions, d) actuating the one or more agrarian equipment positioned in the one or more locations of the field of plant for performing the one or more actions associated with the plant management, based on the generated one or more instructions.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIGS. 1A and 1B illustrate exemplary block diagrams representation of a network architecture depicting an artificial intelligence-based system for performing one or more actions associated with plant management, in accordance with an embodiment of the present disclosure;

FIG. 2 illustrates an exemplary block diagram representation of the computer-implemented system as shown in FIGS. 1A and 1B for performing one or more actions associated with plant management, in accordance with an embodiment of the present disclosure; and

FIG. 3 illustrates an exemplary flow chart of an artificial intelligence-based method for performing the one or more actions associated with plant management, in accordance with an embodiment of the present disclosure; and

FIG. 4 illustrates an exemplary block diagram representation of one or more server platforms for implementation of the disclosed artificial intelligence-based system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

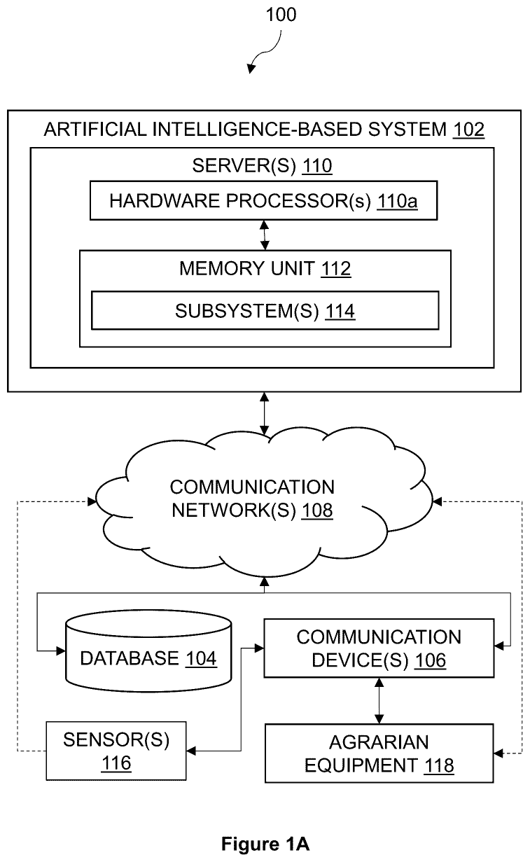

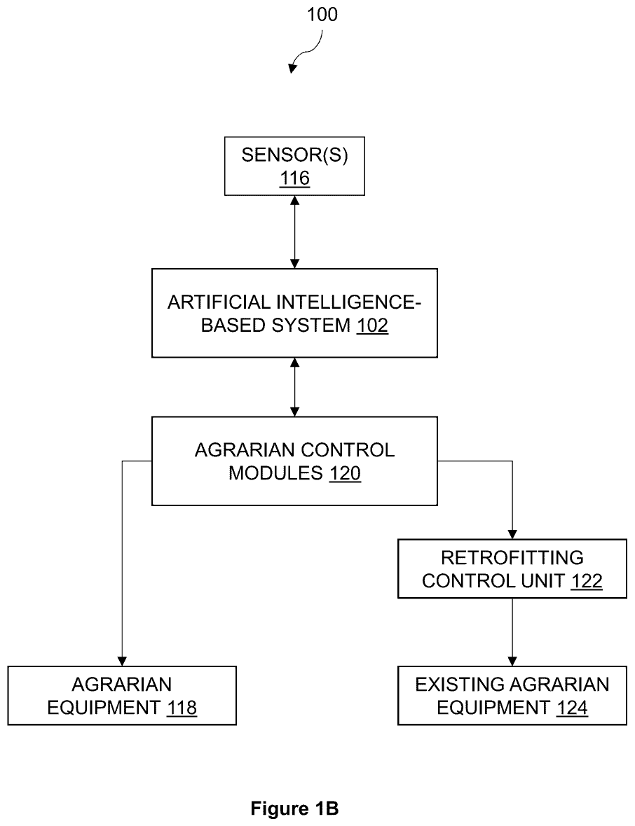

Referring now to the drawings, and more particularly to FIG. 1A through FIG. 4, where similar reference characters denote corresponding features consistently throughout the figures, there are shown preferred embodiments, and these embodiments are described in the context of the following exemplary system and/or method.

The term “plant management” refers to a comprehensive process of monitoring, controlling, and optimizing growth and health of plants, crops, or other flora within a specific area. This includes a wide range of activities to ensure optimal growth conditions and maximize yield while minimizing resource usage and environmental impact. The plant management encompasses various practices such as irrigation, fertilization, pest, and disease control, pruning, harvesting, and soil preparation. The plant management involves the use of advanced technologies, such as sensors, data analytics, and artificial intelligence, to make informed decisions about care and management of plant. By integrating real-time data from environmental conditions, soil health, and crop growth stages, effective plant management seeks to enhance productivity, sustainability, and profitability in agricultural operations.

FIGS. 1A and 1B illustrate exemplary block diagrams representation of a network architecture 100 depicting an artificial intelligence-based system 102 for performing one or more actions associated with plant management, in accordance with an embodiment of the present disclosure.

According to an exemplary embodiment of the present disclosure, the network architecture 100 may include the artificial intelligence-based system 102, a database 104, one or more communication devices 106, one or more sensors 116, and one or more agrarian equipment 118. The artificial intelligence-based system 102 may be communicatively coupled to the database 104, the one or more communication devices 106, the one or more sensors 116, and the one or more agrarian equipment 118 via one or more communication networks 108. The one or more communication networks 108 may be, but not limited to, a wired communication network and/or a wireless communication network. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including 4G and 5G technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the database 104 may include, but not limited to, storing, and managing data related to data related to various aspects of the plant management. The data may encompass pre-defined sensor data, comprises at least one of, but not limited to, soil moisture data, soil pH levels, soil health data, soil composition data, soil temperature data, leaf wetness, micronutrient levels, disease detection data, plant canopy temperature, root zone temperature and the like. The pre-defined sensor data is structured in the database 104 with diverse parameters. The diverse parameters include, but not limited to, at least one of: weather data, precipitation data, agronomic variables data, Solar radiation data, Wind speed and direction data, Humidity levels data, Crop growth stage data, Pest and disease occurrence data, Nutrient application records, Irrigation schedules and history, Harvest data, Topographical data, Water quality data, carbon dioxide levels, Pollination data, Plant health indices (e.g., Normalized Difference Plant Index), Fertilizer application rates and timing, Field management practices (e.g., tillage, crop rotation), Historical yield data, Economic data (e.g., cost of inputs, market prices), Biodiversity indicators (e.g., presence of beneficial insects), Proximity to water sources (e.g., rivers, ponds), and the like associated with one or more locations within a field of plant.

Additionally, the database 104 may store historical environmental data, weather forecasts, and rainfall occurrence information to facilitate predictive analytics. Crop growth patterns, health indicators, and productivity metrics may be maintained in the database 104 to aid in monitoring and optimizing crop yield. Furthermore, the database 104 may include information on field characteristics data, enabling precise irrigation management by accounting for variations in terrain. User preferences and manual inputs regarding irrigation schedules, nutrient applications, and pest control measures may be stored to customize operations of the artificial intelligence-based system 102. The database 104 may also archive data on resource usage, such as water and fertilizer consumption, and financial records related to operational costs, ensuring comprehensive management and optimization of agricultural practices. The database 104 may be any kind of database such as, but not limited to, relational databases, non-relational databases, graph databases, document databases, dedicated databases, dynamic databases, monetized databases, scalable databases, cloud databases, distributed databases, any other databases, and a combination thereof. The database 104 is configured to support the functionality of the artificial intelligence-based system 102 and enables efficient data retrieval and storage for various aspects for performing the one or more actions associated with plant management.

In an exemplary embodiment, one or more communication devices 106 may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, and the like. The one or more communication devices 106 is configured to function as an intermediate unit between the one or more sensors 116, one or more servers 110, and between the one or more servers 110, and the one or more agrarian equipment 118. The one or more communication devices 106 are equipped with one or more user interfaces that allow one or more users to interact with the artificial intelligence-based system 102. The one or more user interfaces may include graphical displays, touchscreens, voice recognition, and other input/output mechanisms that facilitate easy access to data and control functions.

In an exemplary embodiment, the one or more communication devices 106 may provide real-time updates and one or more alerts regarding status of the one or more actions. The one or more communication devices 106 is configured to receive sensor data from the one or more sensors 116 through the one or more communication networks 108 and transferred to the one or more servers 110 for further processing and analysis to generate one or more instructions. the one or more communication devices 106 is configured to receive the one or more instructions and transmit to the one or more agrarian equipment 118 for performing the one or more actions. The one or more actions comprises at least one of, but not limited to, water management, nutrient application, pest control, weed management, growth monitoring, yield prediction, soil health assessment, crop rotation planning, harvesting scheduling, remote monitoring and diagnostics, climate adaptation strategies, and the like.

In an exemplary embodiment, the artificial intelligence-based system 102 may be implemented by way of a single device or a combination of multiple devices that may be operatively connected or networked together. The artificial intelligence-based system 102 may be implemented in hardware or a suitable combination of hardware and software. The computer-implemented system 102 includes one or more servers 110 and is configured with one or more hardware processors 110a and a memory unit 112. The “one or more servers 110” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110a execute a set of computer-readable instructions for dynamically recommending the course of action sequences for performing the one or more actions associated with the plant management. The one or more hardware processors 110a is high-performance processors capable of handling large volumes of data and complex computations. The one or more hardware processors 110a may be, but not limited to, at least one of: multi-core central processing units (CPU), graphics processing units (GPUs), and specialized Artificial Intelligence (AI) accelerators that enhance ability of the artificial intelligence-based system 102 to process real-time data from one or more sources simultaneously. The one or more hardware processors 110a is responsible for executing one or more computational models that analyze the sensor data, predict future conditions, and generate actionable insights for plant management. The one or more hardware processors 110a may also include, for example, microprocessors, microcomputers, microcontrollers, digital signal processors, central processing units, state machines, logic circuits, and/or any devices that manipulate data or signals based on operational instructions. Among other capabilities, the one or more hardware processors 110a may fetch and execute the set of computer-readable instructions in the memory unit 112 operationally coupled with the artificial intelligence-based system 102 for performing tasks such as data processing, input/output processing, and/or any other functions. Any reference to a task in the present disclosure may refer to an operation being or that may be performed on data.

The memory unit 112, which works in conjunction with the one or more hardware processors 110a, is configured to store and manage the vast amounts of data collected from the one or more sensors 116 and the one or more sources. The memory unit 112 is composed of at least one of: a non-transitory volatile memory and the non-volatile memory, ensuring that data is readily accessible for processing while also being securely stored for long-term analysis and historical reference. The memory unit 112. The memory unit 112 may include a plurality of subsystems 114.

In an exemplary embodiment, the one or more sensors 116 is operatively positioned in the field of plant. The one or more sensors 116 is configured to generate the sensor data. The sensor data comprises, but not limited to, at least one of: soil moisture data, soil pH levels, soil health data, soil composition data, soil temperature data, leaf wetness, micronutrient levels, disease detection data, plant canopy temperature, root zone temperature, and the like. The one or more sensors 116 is strategically placed at various locations within the field of plant to ensure comprehensive coverage and accurate monitoring. The one or more sensors 116 comprises, but not limited to, at least one of: moisture sensors, pH sensors, soil health sensors, soil composition sensors, soil temperature sensors, leaf wetness sensors, micronutrient sensors, disease detection sensors, plant canopy temperature sensors, root zone temperature sensors, and the like. The one or more sensors 116 may be implemented by way of a single device or a combination of multiple devices that may be operatively connected or networked together. Those of ordinary skilled in the art may utilize the one or more sensors 116 that are available in the prior art for managing the plant by connecting those sensors with the artificial intelligence-based system 102.

The moisture sensors are deployed at different depths to monitor water content within a root zone, aiding to optimize irrigation schedules and preventing both over-watering and under-watering. The pH sensors is configured to provide critical information on at least one of an: acidity and alkalinity of the soil, which is vital for maintaining optimal nutrient availability and preventing conditions to monitor the plant. The soil health sensors collect data on a biological activity and organic matter content, offering insights into soil fertility and an effectiveness of soil management practices. The soil composition sensors analyze one or more proportions of sand, silt, and clay, which influence water retention, drainage, and root penetration. The soil temperature sensors track a temperature at various depths, aiding in the assessment of soil conditions that affect seed germination and root development. The leaf wetness sensors measure a presence of moisture on plant surfaces, which may be indicative of at least one of: dew formation, rain, and irrigation, and are crucial for disease prediction and management.

The micronutrient sensors detect one or more levels of essential trace elements comprised of, but not limited to, zinc, copper, and manganese, ensuring that the plant receives necessary nutrients for optimal growth. The disease detection sensors identify early signs of plant diseases through changes in at least one of: biochemical markers and visual symptoms, enabling timely interventions to prevent outbreaks. The plant canopy temperature sensors monitor the temperature of one or more plant leaves and stems, providing data on plant health and stress levels. Root zone temperature sensors offer insights into the thermal environment of a root structure, which affects water uptake and nutrient absorption.

The selection of the one or more sensors 116 is configured to withstand harsh environmental conditions and provide reliable, real-time data to the artificial intelligence-based system 102. The sensor data collected from these one or more sensors 116 is transmitted to the database 104 via the one or more communication networks 108, where it is stored, processed, and analyzed to generate actionable insights and recommendations for plant management. The sensor data is configured to at least one of: a) actuate the one or more agrarian equipment, depict the real-time status of the plant on the user interface associated with the one or more communication devices 106, and c) provide one or more alerts, and recommendations to the user based on real-time conditions and predictive analytics. The real-time status updates include visual and numerical data representations, making it easier for the one or more users to understand current conditions and make informed decisions. The one or more alerts and one or more recommendations are generated by the artificial intelligence-based system 102, which analyzes the sensor data in conjunction with historical and contextual information to optimize plant management practices.

In an exemplary embodiment, one or more agrarian equipment 118 is operatively connected to the one or more servers 110. The one or more agrarian equipment 118 comprises, but not limited to, at least one of: sprinklers, drip irrigation units, smart valves, plows, harrows, tillers, cultivators, seeders, planters, transplanters, fertilization drones, weeding robots, pruning equipment, combine harvesters, reapers, balers, tractors, trailers, conveyors, threshers, grain dryers, storage bins, and the like. The one or more agrarian equipment 118 may be at least one of: one or more conventional agrarian equipment and one or more smart agrarian equipment. The one or more smart agrarian equipment is operatively connected to the one or more servers 110 through the one or more communication networks 108, conversely, the one or more conventional agrarian equipment is operatively connected through a retrofitting control unit 122.

Though few components and the plurality of subsystems 114 are disclosed in FIG. 1, there may be additional components and subsystems which is not shown, such as, but not limited to, ports, routers, repeaters, firewall devices, network devices, the databases 104, network attached storage devices, assets, machinery, instruments, facility equipment, emergency management devices, image capturing devices, any other devices, and combination thereof. The person skilled in the art should not be limiting the components/subsystems shown in FIGS. 1A and 1B. Although FIG. 1A and 1B illustrate the artificial intelligence-based system 102, and the one or more communication devices 106 connected to the database 104, one skilled in the art can envision that the artificial intelligence-based system 102, and the one or more communication devices 106 may be connected to several user devices located at various locations and several databases via the one or more communication networks 108.

Those of ordinary skilled in the art will appreciate that the hardware depicted in FIGS. 1A and 1B may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the artificial intelligence-based system 102 as is unique to the present disclosure or necessary for an understanding of the present disclosure is depicted and described. The remainder of the construction and operation of the artificial intelligence-based system 102 may conform to any of the various current implementations and practices that were known in the art.

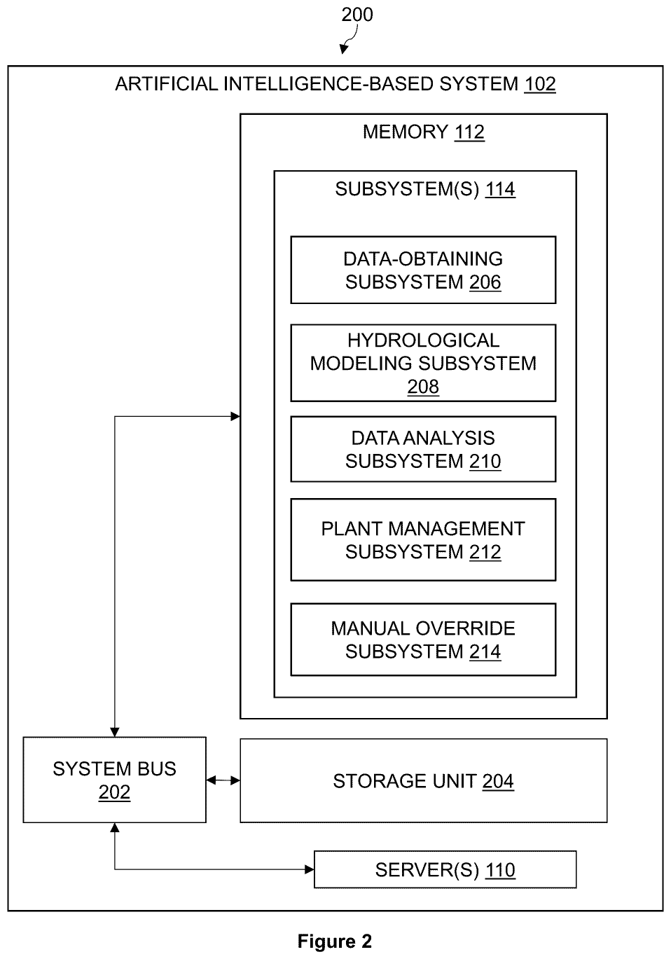

FIG. 2 illustrates an exemplary block diagram representation of the artificial intelligence-based system 102 as shown in FIGS. 1A and 1B for performing the one or more actions associated with plant management, in accordance with an embodiment of the present disclosure.

In an exemplary embodiment, the artificial intelligence-based system 102 (hereinafter referred to as the system 102). The system 102 comprises the one or more servers 110, the memory unit 112, and a storage unit 204. The one or more servers 110, the memory unit 112, and the storage unit 204 are communicatively coupled through a system bus 202 or any similar mechanism. The memory unit 112 is operatively connected to the one or more servers 110. The memory unit 112 comprises the plurality of subsystems 114 in the form of programmable instructions executable by the one or more servers 110.

The plurality of subsystems 114 comprises a data-obtaining subsystem 206, a hydrological modeling subsystem 208, a data analysis subsystem 210, a plant management subsystem 212, and a manual override subsystem 214. The one or more hardware processors 110a associated within the one or more servers 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110a may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more servers 110, such as being a computer-readable storage medium. The one or more servers 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more servers 110.

The storage unit 204 may be a cloud storage or the database 104 such as those shown in FIGS. 1A and 1B. The storage unit 204 may store, but not limited to, recommended course of action sequences dynamically generated by the system 102. These action sequences are based on at least one of the: the sensor data, weather data, precipitation data, agronomic variables data and one or more computational models' applications. Additionally, the storage unit 204 may store historical data, and other relevant information necessary for performing the one or more actions associated with plant management. By centralizing this information in the storage unit 204, the system 102 is able to access and retrieve it efficiently and actuate the one or more agrarian equipment positioned in the one or more locations of the field of plant. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the data-obtaining subsystem is configured to obtain at least one of: the sensor data from the one or more sensors 116 deployed in the field of the plant. The sensor data comprises one or more parameters to such as, but not limited to, at least one of the: soil moisture data, soil pH levels, soil health data, soil composition data, soil temperature data, leaf wetness, micronutrient levels, disease detection data, plant canopy temperature, root zone temperature, and the like in a real-time. This real-time sensor data is vital for assessing the current state of the field and making immediate adjustments to the one or more agrarian equipment.

In an exemplary embodiment, the data-obtaining subsystem is configured to obtain the weather data, and the precipitation data associated with one or more locations of the field of plant. The weather data, and the precipitation data is obtained from at least one of: a user manual input, on-site weather sensors, satellite-based monitoring, Internet of Things (IoT) weather stations, weather application programming interfaces (APIs), weather forecast models, weather data integration platforms, one or more communication device applications, and the like. The system 102 is configured to allow the one or more users to manually input weather observations via the one or more communication devices 106 through the one or more user interfaces. The on-site weather sensors are deployed in the field of plant for providing localized and precise weather data directly from the field. The satellite-based monitoring offers comprehensive and wide-ranging weather data, including cloud cover, rainfall, and temperature. The IoT weather stations continuously monitor and report weather conditions. The weather APIs integrate weather data from various online services and external databases to provide to the system 102. The system 102 may be configured with weather forecast models to predict future weather patterns based on weather historical data and current conditions. The weather data integration platforms are configured to aggregate and normalize data from multiple sources for cohesive analysis. The one or more communication device applications such as, but limited to, mobile phones, and desktop applications enable users to access and input weather data seamlessly.

In an exemplary embodiment, the data-obtaining subsystem is configured to obtain the agronomic variables data from one or more communication devices 106 configured with the system 102, through the one or more user interfaces from the one or more users. The agronomic variables data comprises, but not limited to, at least one of: flora-type data, growth stage data, and field characteristics data. The flora-type data comprises at least one of: crop types, plant species, and plant density, providing information on the diversity and distribution of plants in the field. The growth stage data comprises, but not limited to, at least one of a: seedling stage, vegetative stage, flowering stage, fruiting stage, and ripening stage. Understanding these stages assists in timing interventions appropriately. The field characteristics data comprises, but not limited to, at least one of: soil types, soil compositions, gradient of a field inclinations, field sizes, and drainage characteristics. This characteristics data assists in tailoring the management practices to the specific needs and conditions of the field and also utilized for computing at least one of: interpolate sensor data and extrapolate sensor data to minimize the usage of number of sensors 116 of the one or more sensors 116.

The one or more hardware processors 110a is configured to compile at least one of the: sensor data, weather data, precipitation data, and agronomic variables data from the one or more sensors 116, weather sources, and user inputs into a cohesive dataset stored in the database 104. The one or more hardware processors 110a is configured to analyze incoming data to provide immediate insights and recommendations. The one or more hardware processors 110a is configured to utilize historical data and the one or more computational models to forecast future conditions and crop performance.

In an exemplary embodiment, the hydrological modeling subsystem 208 is an integral part of the system 102, configured to enhance a precision and effectiveness of plant management through advanced computational techniques. The hydrological modeling subsystem 208 leverages the one or more computational models to accurately assess and predict water distribution and usage across the field of plant. The hydrological modeling subsystem 208 is configured to determine at least one of: interpolate sensor data and extrapolate sensor data, between the one or more sensors 116.

The interpolate sensor data is determined by leveraging at least one of: one or more machine learning models and one or more analytical models associated with the one or more computational models for estimating intermediate values between at least two or more sensors 116 of the one or more sensors 116. For example, if the soil moisture sensors are placed at different points within the field, the hydrological modeling subsystem 208 is able to estimate the soil moisture levels at points between the at least two or more sensors. This interpolation data is crucial for creating a continuous and comprehensive moisture map of the entire field, ensuring no area is overlooked. The extrapolate sensor data is determined by leveraging at least one of the: one or more machine learning models and one or more analytical models associated with the one or more computational models for predicting sensor data beyond the range of the at least two or more sensors 116 based on observed trends and patterns. For instance, if the at least two or more sensors 116 detect decreasing moisture levels, the hydrological modeling subsystem 208 is able to predict future moisture levels in unsensed areas, allowing for initiative-taking irrigation planning.

At least one of the: interpolate sensor data and extrapolate sensor data are determined based on several critical factors, including, but not limited to, at least one of: water evaporation rates and the agronomic variables data of an associated location of the one or more locations of the field of plant. The hydrological modeling subsystem 208 is configured to consider the rate at which water evaporates from the soil and plant surfaces. The evaporation rates are influenced by factors such as temperature, humidity, wind speed, and solar radiation. By incorporating these variables, the hydrological modeling subsystem 208 is configured to accurately model the water needs of the plant and adjust irrigation schedules accordingly. The hydrological modeling subsystem 208 utilizes the agronomic variables data specific to the field location. The agronomic variables data allows the hydrological modeling subsystem 208 to tailor the one or more computational models to the unique conditions of each field, ensuring optimal water usage.

In an exemplary embodiment, the one or more machine learning models is configured to analyze at least one of the: sensor data, interpolate sensor data, and extrapolate sensor data to identify patterns of the soil moisture data and forecast the soil moisture levels for performing the one or more actions associated with the plant management based on diverse conditions. The one or more machine learning models comprises, but not limited to, at least one of: linear regression, polynomial regression, the decision trees, random forests, the gradient boosting machines (GBM), the support vector machines (SVM), the K-nearest neighbors (KNN), the Bayesian networks, clustering models, and the like. In an exemplary embodiment, the linear regression is utilized for its simplicity and effectiveness in modeling the relationship between soil moisture levels and influencing factors such as temperature and humidity. The polynomial regression is applied to capture non-linear relationships within the sensor data, providing a more accurate fit for complex patterns. The decision trees present a visual and interpretable structure for decision-making processes based on the sensor data, facilitating straightforward irrigation actions. The random forests are an ensemble learning method that improves prediction accuracy by combining multiple decision trees, reducing the risk of overfitting. The GBM model enhances prediction performance by sequentially building trees that correct errors from previous iterations, resulting in robust and accurate moisture forecasts. The SVM is effective in high-dimensional spaces, The SVMs classify and predict soil moisture conditions by finding the optimal hyperplane that separates different moisture levels. The KNN is a non-parametric algorithm that predicts soil moisture by averaging the moisture levels of the nearest data points, useful for real-time updates. The Bayesian Networks are the probabilistic models that represent the dependencies among various factors influencing soil moisture, offering insights into cause-and-effect relationships. The Clustering Models such as a K-means clustering group extract similar data points, identifying distinct zones within the field with unique moisture needs.

The one or more analytical models is configured to determine at least one of the: interpolate sensor data and extrapolate sensor data for performing the one or more actions associated with the plant management based on the water evaporation rates. The one or more analytical models comprises, but not limited to, at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, water budget models, and the like. In an exemplary embodiment, the linear interpolation models use straight-line estimates between the one or more sensors 116 to predict soil moisture, providing a simple and quick method for estimation. The linear extrapolation models are similar to linear interpolation. These linear extrapolation models extend existing data trends to predict future values, useful for short-term forecasting. The polynomial interpolation models are configured to fit one or more polynomial functions to the sensor data, these polynomial interpolation models is able to capture more complex relationships and provide more accurate soil moisture estimates between the two or more sensors 116. The polynomial extrapolation models extend polynomial trends beyond an existing sensor data range to predict future values, accommodating more intricate patterns in soil moisture changes. The spline interpolation is a method uses piecewise polynomials to fit the sensor data, providing smooth and continuous estimates that are particularly useful for capturing gradual changes in soil moisture. The IDW technique estimates the soil moisture by averaging the values of nearby sensors 116 of the one or more sensors 116, weighted by their distance, providing a localized estimation that considers spatial variability. The kriging is an advanced geostatistical method that not only interpolates data but also provides estimates of the uncertainty, offering a sophisticated approach to the spatial variability of soil moisture. The FEM is numerical technique that solves complex partial differential equations that describe soil moisture movement, providing detailed and accurate estimates for various soil types and conditions. The Richards equation models are configured to solve a Richards equation, which describes water flow in unsaturated soils, to predict soil moisture dynamics based on physical principles. The SMA models track soil moisture changes over time, considering inputs like rainfall and irrigation and outputs like evaporation and plant uptake. The evapotranspiration models estimate a combined water loss from soil evaporation and plant transpiration, crucial for understanding and managing water needs in plant management. The hydrological balance models are configured to compute a water balance in the soil, considering all inputs and outputs to provide a comprehensive understanding of soil moisture dynamics. The van genuchten model describes water retention characteristics of soils, providing insights into how soil moisture changes with varying water content and matric potential. The water budget models assess an overall water budget in the soil, accounting for all sources and sinks of water to provide a holistic view of soil moisture status.

In an exemplary embodiment, the data analysis subsystem 210 is configured with the one or more computational models to perform a comparative analysis between the obtained sensor data and pre-defined sensor data stored in the database 104. The comparative analysis is performed based on at least one of the: weather data, precipitation data, agronomic variables data, interpolate sensor data, and extrapolate sensor data, to generate one or more instructions. The data analysis subsystem 210 is configured to compare real-time sensor data obtained from the one or more sensors 116 with historical and pre-defined data to identify discrepancies, trends, and patterns. The comparative analysis process involves sophisticated data processing techniques to ensure accuracy and relevance. The data analysis subsystem 210 utilizes at least one of: one or more artificial intelligence (AI) models and the one or more machine learning (ML) models. At least one of the: one or more artificial intelligence (AI) models and analyze vast amounts of sensor data to produce actionable insights.

The one or more instructions generated by the data analysis subsystem 210 include, but are not limited to, at least one of: irrigation schedule data, water amount data, irrigation duration data, irrigation frequency data, zone-specific irrigation data, soil moisture target levels, notifying the micronutrient levels, one or more alerts for manual intervention, one or more fertilization schedule alerts, pest and disease control instructions, pruning schedules, optimal harvest times, crop rotation recommendations, drainage management instructions, one or more water quality monitoring alerts, remote system diagnostics, one or more irrigation system maintenance alerts, and the like. The irrigation schedule data recommends when to water the plant, considering factors like weather forecasts and soil moisture levels. The water amount data recommends specific quantities of water needed for optimal crop growth, while irrigation duration data determines a precise length of time for irrigation.

Additionally, irrigation frequency data outlines how often irrigation should occur, tailored to the specific needs of different crop types and growth stages. The zone-specific irrigation data offers customized irrigation plans for different zones within the field, ensuring each area receives the appropriate amount of the water. The soil moisture target levels indicate ideal soil moisture levels to maintain healthy crop growth. The micronutrient level notifications alert when micronutrient levels are outside optimal ranges, enabling timely interventions. The one or more manual intervention alerts notify when the one or more users intervention is required, such as equipment maintenance or manual watering through the one or more user interfaces. The one or more fertilization schedule alerts provide recommendations for a timing and amount of fertilizer application. The pest and disease control instructions offer guidance on managing pests and diseases, including the use of pesticides and other control measures.

The pruning schedules recommend the best times to prune plants to promote healthy growth, which is depicted on the one or more user interfaces. The optimal harvest times notify the best times to harvest crops based on growth stages and environmental conditions. The crop rotation recommendations suggest rotating crops to maintain soil health and reduce pest infestations, which is depicted on the one or more user interfaces. The drainage management instructions provide guidance on managing water drainage to prevent waterlogging and soil erosion. The one or more water quality monitoring alerts notify the one or more users when water quality falls outside acceptable parameters, prompting corrective actions. The remote system diagnostics offer the one or more alerts and recommendations for diagnosing and troubleshooting system 102 issues remotely, while the one or more irrigation system maintenance alerts notify about routine maintenance of irrigation systems to ensure optimal performance.

The data analysis subsystem 210 is configured to perform one or more actions in real-time, utilizing real-time feedback from diverse sources such as the sensor data, weather data, and precipitation data. This real-time capability ensures that the system 102 adapts quickly to changing environmental conditions, providing timely and accurate recommendations for plant management.

The one or more artificial intelligence models is configured to analyze the pre-defined sensor data obtained in the database 104 for updating required soil moisture levels for the diverse flora-type data in the database 104 with respect to at least one of the: weather data, precipitation data, and agronomic variables data. The one or more artificial intelligence models comprises, but not limited to, at least one of: artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), fuzzy logic systems, and the like. The ANN models simulate a human brain's network of neurons to recognize patterns and relationships in the sensor data.

The ANN models are particularly useful for nonlinear data analysis and predictive modeling. The deep learning models are a subset of ANNs with multiple layers that are able to learn representations of the sensor data with increasing levels of abstraction, which is crucial for handling large and complex datasets in plant management. The CNNs are primarily used for image recognition and classification, the CNNs may be applied to analyze aerial or satellite images of fields to monitor crop health and detect anomalies. The RNN models are effective for sequential data analysis, such as time-series data on soil moisture and weather patterns, enabling the system 102 to make more accurate predictions. The SVMs are supervised learning models that are able to classify data and predict trends based on training data, useful for categorizing diverse types of soil and crop conditions. The decision trees are the models utilize the tree-like graph of decisions and their possible consequences to make predictions, which facilitates understanding a decision-making process in plant management.

The random forests ensemble learning method uses multiple decision trees to improve accuracy and robustness of predictions. The GBM models build predictive models in a stage-wise fashion and are used to optimize performance by minimizing errors in plant management tasks. The Bayesian networks use probabilities to represent uncertain relationships between different variables, useful for managing the uncertainties in weather and crop conditions. The KNN is an instance-based learning procedure that classifies the sensor data based on closest training examples, useful for pattern recognition in soil and crop data. The fuzzy logic systems manage reasoning that is approximate rather than fixed and exact, which is beneficial for dealing with the imprecise nature of agricultural data.

In an exemplary embodiment, the plant management subsystem 212 is configured to autonomously actuate the one or more agrarian equipment 118 positioned in the one or more locations of the field of plant. The one or more agrarian equipment 118 is configured to perform the one or more actions associated with the plant management, based on the generated one or more instructions. The plant management subsystem 212 is configured to autonomously actuate the one or more agrarian equipment 118, minimizing the need for one or more user interventions. This autonomous actuation of the one or more agrarian equipment 118 through one or more agrarian control modules 120. The one or more agrarian control modules 120 is responsible for executing the one or more instructions on the one or more agrarian equipment. The one or more agrarian control modules 120 is configured to manage various operations at distinct levels within the field comprises, but not limited to, at least one of: entire plant, zone-specific within the plant, and pattern-specific within the plant. The plant management subsystem 212 is configured to coordinate the one or more actions across the entire field to ensure uniform application of irrigation, fertilization, pest control, and other tasks. The plant management subsystem 212 is configured to customize the one or more actions for specific zones within the field to address the unique needs of different areas, such as, but not limited to, at least one of: varying soil types, moisture levels, and the like. The plant management subsystem 212 is configured to implement specific patterns for performing the one or more actions like at least one of, but not limited to, the irrigation and planting to optimize resource use and improve crop yield. The one or more agrarian equipment comprises at least one of: one or more irrigation equipment, one or more soil preparation equipment, one or more planting equipment, one or more crop maintenance tools, one or more harvesting machinery, one or more transport equipment, one or more post-harvest equipment, and one or more pest control equipment. The one or more irrigation equipment are the devices such as, but not limited to, at least one of the: sprinklers, drip irrigation units, and smart valves that control water distribution based on the real-time soil moisture data and weather data. The one or more soil preparation equipment may comprise tools such as, but not limited to, at least one of the: plows, harrows, and tillers that prepare the soil for planting by breaking up the soil, mixing in fertilizers, and leveling the field. The one or more planting equipment is a machinery such as, but not limited to, at least one of the: seeders, planters, and transplanters that accurately plant seeds or seedlings at optimal depths and spacings. The one or more crop maintenance tools may be the equipment like fertilization drones, weeding robots, and pruning devices that assist maintain the health of the crops by delivering nutrients, removing weeds, and trimming plants as needed. The one or more harvesting machinery comprises, but not limited to, at least one of the: combine harvesters, reapers, and balers that efficiently harvest crops and prepare them for storage or transport. The one or more transport equipment comprises, but not limited to, at least one of the: tractors, trailers, and conveyors that move harvested crops and materials around the field and to storage facilities. The one or more post-harvest equipment comprises at least one of the: threshers, grain dryers, and storage bins that handle post-harvest processing to preserve crop quality and prepare them for market. The one or more pest control equipment comprises at least one of the: sprayers for pesticides and drones equipped with sensors to detect and target pest infestations.

In an exemplary embodiment, the system 102 comprises a manual override subsystem 214. The manual override subsystem 214 is configured to perform the one or more actions through the user interface associated with the one or more communication devices 106. This allows the one or more users to manually control and adjust the system operations when necessary, providing flexibility and ensuring that the one or more users is able to intervene in critical situations or customize the system's actions according to specific needs. The system 102 is configured with the retrofitting control unit 122. The retrofitting control unit 122 is configured to interface with one or more existing agrarian equipment 124 by employing at least one of a: retrofitting controller, retrofitting adapter, programmable logic controllers (PLCs), electrically controlled valves, and modular sensor interfaces, via one or more communication networks, for performing the one or more actions. The retrofitting controller is a specialized device that bridges the gap between the one or more existing agrarian equipment 124 and the system 102, allowing for seamless communication and control. The retrofitting adapter is a hardware adapter that physically connect the one or more existing agrarian equipment 124 to the system 102, enabling data transmission and control commands to flow between the system 102 and the one or more existing agrarian equipment 124. The PLCs are the industrial digital computers that have been adapted for the control of manufacturing processes, including agricultural machinery. The PLCs may be programmed to automate the one or more existing agrarian equipment operations and able to interface with the system 102 to execute the one or more actions. The electrically controlled valves are smart valves that are electronically manipulated to control the flow of water, fertilizers, or other inputs. These controlled valves are integrated into the existing irrigation systems and controlled via the system 102. The modular sensor interfaces connect various sensors to the system 102, allowing it to receive and process data from the one or more existing agrarian equipment 124. The modular sensor interfaces ensure compatibility and effective data communication between old and modern technologies.

The one or more comprises at least one of the, but not limited to, water management, nutrient application, pest control, weed management, growth monitoring, yield prediction, soil health assessment, crop rotation planning, harvesting scheduling, remote monitoring and diagnostics, climate adaptation strategies, and the like. The system 102 is configured to dynamically adjust irrigation schedules, duration, and frequency based on the sensor data to ensure optimal water usage tailored to the specific needs of different crops and growth stages. This capability minimizes water wastage and maximizes crop yield. The system 102 is configured to provide one or more alerts to the one or more user via the one or more communication devices 106 about precise recommendations for fertilization timing, type, and amount based on soil nutrient levels, crop requirements, and growth stages. This promotes efficient nutrient utilization, reduces environmental impact, and enhances soil fertility. The system 102 monitors pest populations through sensor data and provides timely one or more alerts and recommendations for pest management strategies, including the application of pesticides or biological control methods. This initiative-taking approach helps minimize crop damage and loss. The system 102 is configured to utilize the sensor data and the one or more machine learning models to identifies weed presence and density, enabling targeted herbicide application or mechanical weed control measures. This improves crop competitiveness and reduces weed-related yield losses. The system 102 is configured to continuously monitor the plant growth parameters such as canopy temperature, leaf health, and growth rates allowing to track crop development accurately. This information supports timely interventions and adjustments to optimize growing conditions. By analyzing historical data, current growth trends, and environmental conditions, the system 102 employs predictive analytics to forecast crop yields. These insights enable the one or more users to make informed decisions regarding harvest planning and marketing strategies. The system 102 is configured to execute comprehensive analysis of soil properties, including pH levels, nutrient content, and microbial activity, informs decisions on soil management practices such as tillage, organic matter application, and erosion control measures. This promotes soil health and long-term productivity. The system 102 is configured to recommend crop rotation sequences based on historical performance data, soil health indicators, and pest management considerations. The crop rotation assists in preventing disease buildup, improves soil structure, and enhances overall farm sustainability. The system 102 determines optimal harvest times based on crop maturity indicators, weather forecasts, and market conditions. This ensures crops are harvested at peak quality and yield, minimizing post-harvest losses. Real-time monitoring of the one or more agrarian equipment status, environmental conditions, and crop health parameters allows for remote troubleshooting and initiative-taking maintenance. This capability enhances operational efficiency and reduces downtime. The system employs adaptive management practices based on climate data trends and forecasts to mitigate risks associated with climate variability. This includes adjusting planting dates, irrigation schedules, and crop selection to optimize resilience and productivity under changing climatic conditions.

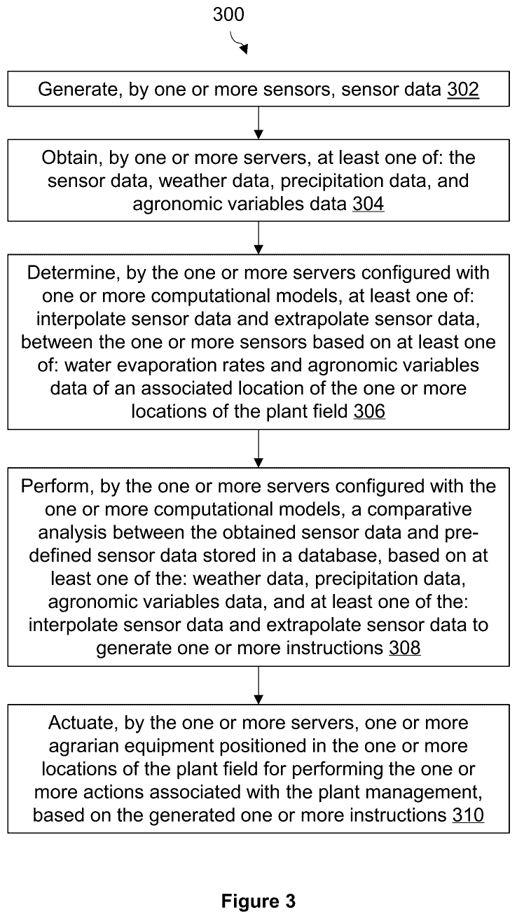

FIG. 3 illustrates an exemplary flow chart of an artificial intelligence-based method 300 for performing the one or more actions associated with the plant management, in accordance with an embodiment of the present disclosure.

In accordance with an embodiment of the present disclosure, an artificial intelligence-based method 300 for performing the one or more actions associated with plant management is disclosed. At step 302, the artificial intelligence-based method 300 includes generating, by the one or more sensors, the sensor data. At step 304, the artificial intelligence-based method 300 includes obtaining, by the one or more servers, at least one of the: sensor data, weather data, precipitation data, and agronomic variables data. This sensor data-obtaining process ensures that real-time environmental conditions and crop-specific requirements are continuously monitored and analyzed. At step 306, the artificial intelligence-based method 300 includes determining, by the one or more servers configured with one or more computational models, at least one of the: interpolate sensor data and extrapolate sensor data, between the one or more sensors based on at least one of the: water evaporation rates and agronomic variables data of an associated location of the one or more locations of the field of plant. The interpolate sensor data is determined by leveraging at least one of: one or more machine learning models and one or more analytical models associated with the one or more computational models for estimating intermediate values between at least two or more sensors of the one or more sensors. The extrapolate sensor data is determined by leveraging at least one of the: one or more machine learning models and one or more analytical models associated with the one or more computational models for predicting sensor data beyond the range of the at least two or more sensors based on observed trends and patterns.

At step 308, the artificial intelligence-based method 300 includes performing, by the one or more servers configured with the one or more computational models, the comparative analysis between the obtained sensor data and the pre-defined sensor data stored in the database, based on at least one of the: weather data, precipitation data, agronomic variables data, and at least one of the: interpolate sensor data and extrapolate sensor data to generate the one or more instructions. The one or more instructions comprises, but not limited to, at least one of: irrigation schedule data, water amount data, irrigation duration data, irrigation frequency data, zone-specific irrigation data, soil moisture target levels, notifying the micronutrient levels, one or more alerts for manual intervention, one or more fertilization schedule alerts, pest and disease control instructions, pruning schedules, optimal harvest times, crop rotation recommendations, drainage management instructions, one or more water quality monitoring alerts, remote system diagnostics, one or more irrigation system maintenance alerts, and the like.

Further, at step 310, the artificial intelligence-based method 300, includes actuating, by the one or more servers, the one or more agrarian equipment positioned in the one or more locations of the field of plant for performing the one or more actions associated with the plant management, based on the generated one or more instructions. The one or more servers is configured to autonomously actuate the one or more agrarian equipment through one or more agrarian control modules. The one or more agrarian control modules execute the one or more instructions to actuate the one or more agrarian equipment for performing the one or more actions in the field of at least one of the: entire plant, zone-specific within the plant, and pattern-specific within the plant. The one or more agrarian equipment comprises, but not limited to, at least one of: one or more irrigation equipment, one or more soil preparation equipment, one or more planting equipment, one or more crop maintenance tools, one or more harvesting machinery, one or more transport equipment, one or more post-harvest equipment, one or more pest control equipment, and the like.

The artificial intelligence-based method 300 is configured to interface with one or more existing agrarian equipment by employing at least one of a: retrofitting controller, retrofitting adapter, programmable logic controllers (PLCs), electrically controlled valves, and modular sensor interfaces, via one or more communication networks, for performing the one or more actions. The one or more computational models comprises at least one of the: one or more artificial intelligence models, one or more machine learning models, and one or more analytical models. The one or more artificial intelligence models is configured to analyze the pre-defined sensor data obtained in the database for updating required soil moisture levels for the diverse flora-type data in the database with respect to at least one of the: weather data, precipitation data, and agronomic variables data. The one or more artificial intelligence models comprises at least one of: artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), and fuzzy logic systems.

The one or more machine learning models is configured to analyze the sensor data to identify patterns of the soil moisture data and forecast the soil moisture levels for performing the one or more actions associated with the plant management based on diverse conditions. The one or more machine learning models comprises at least one of: linear regression, polynomial regression, the decision trees, random forests, the gradient boosting machines (GBM), the support vector machines (SVM), the K-nearest neighbors (KNN), the Bayesian networks, and clustering models.

The one or more analytical models configured to determine at least one of the: interpolate sensor data and extrapolate sensor data for performing the one or more actions associated with the plant management based on the water evaporation rates. The one or more analytical models comprises at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, and water budget models.

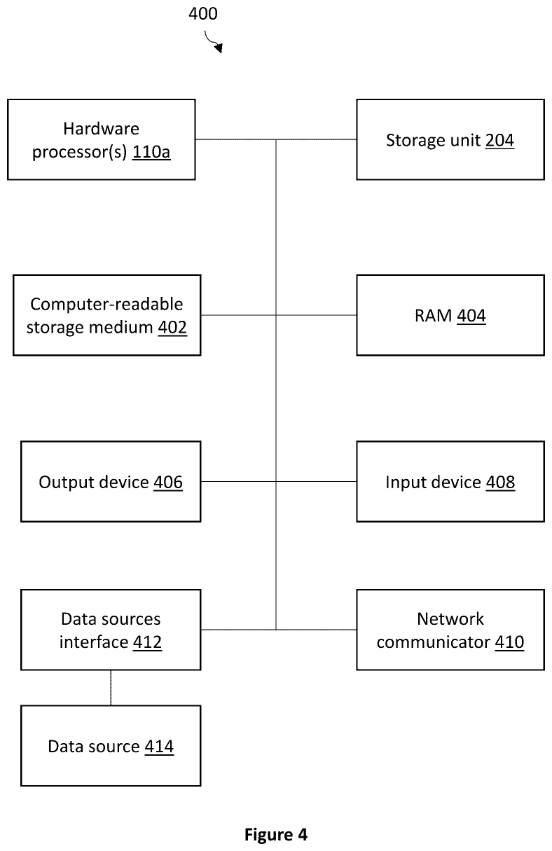

FIG. 4 illustrates an exemplary block diagram representation of one or more server 400 platforms for implementation of the disclosed artificial intelligence-based system 102, according to an example embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the server platform 400. As illustrated, the server platform 400 may include additional components not shown, and some of the components described may be removed and/or modified. For example, a computer system with the multiple graphics processing units (GPUs) may be located on at least one of: internal printed circuit boards (PCBs) and external-cloud platforms including Amazon Web Services, internal corporate cloud computing clusters, or organizational computing resources.

The server platform 400 may be a computer system such as the system 102 that may be used with the embodiments described herein. The computer system may represent a computational platform that includes components that may be in one or more servers 110 or another computer system. The computer system may be executed by the one or more hardware processors 110a (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 110a that execute software instructions or code stored on a non-transitory computer-readable storage medium 402 to perform methods of the present disclosure. The software code includes, for example, instructions to gather data and analyze the sensor data. For example, the plurality of subsystems 114 includes the data-obtaining subsystem 206, the hydrological modeling subsystem 208, the data analysis subsystem 210, the plant management subsystem 212, and the manual override subsystem 214.

The instructions on the computer-readable storage medium 402 are read and stored the instructions in the storage unit or random-access memory (RAM) 404. The storage unit 204 may provide a space for keeping static data where at least some instructions could be stored for later execution. The stored instructions may be further compiled to generate other representations of the instructions and dynamically stored in the RAM 404. The one or more hardware processors 110a may read instructions from the RAM 404 and perform actions as instructed.

The computer system may further include an output device 406 to provide at least some of the results of the execution as output including, but not limited to, visual information to the one or more users, such as farmers. The output device 406 may include a display on computing devices and virtual reality glasses. For example, the display may be a mobile phone screen or a laptop screen. GUIs and/or text may be presented as an output on the display screen. The computer system may further include an input device 408 to provide a user or another device with mechanisms for entering data and/or otherwise interacting with the computer system. The input device 408 may include, for example, a keyboard, a keypad, a mouse, or a touchscreen. Each of these output devices 406 and input device 408 may be joined by one or more additional peripherals.

A network communicator 410 may be provided to connect the computer system to a network and in turn to other devices connected to the network including other entities, servers, data stores, and interfaces. The network communicator 410 may include, for example, a network adapter such as a LAN adapter or a wireless adapter. The computer system may include a data sources interface 412 to access a data source 414. The data source 414 may be an information resource about the plant. As an example, the database 102 of exceptions and rules may be provided as the data source 414. Moreover, knowledge repositories and curated data may be other examples of the data source 414. The data source 414 may include libraries containing, but not limited to, soil composition data, historical weather patterns, crop growth databases, pest and disease incidence records, irrigation logs, soil moisture profiles, nutrient availability datasets, agronomic best practices, crop rotation schedules, plant phenology data, yield statistics, satellite imagery archives, remote sensing data, expert agronomist recommendations, machine learning model outputs, real-time sensor data streams, and the like. These comprehensive data libraries facilitate a holistic understanding of the plant management ecosystem, enabling informed decision-making and optimizing agricultural practices.

Numerous advantages of the present disclosure may be apparent from the discussion above. In accordance with the present disclosure, the artificial intelligence-based system for performing the one or more actions associated with plant management offers several significant benefits. Firstly, the artificial intelligence-based system enhances water management efficiency by utilizing real-time sensor data and the one or more computational models to precisely determine irrigation needs. This reduces water wastage and optimizes resource utilization. Secondly, the integration of diverse sensor data with weather forecasts and agronomic variables enables the artificial intelligence-based system to provide tailored recommendations for nutrient application, pest control, and other critical farming activities, ensuring that interventions are timely and effective.

Furthermore, the artificial intelligence-based system is able to perform comparative analysis and predictive modeling allows for accurate yield predictions and growth monitoring, facilitating proactive decision-making and strategic planning. The autonomous actuation of the one or more agrarian equipment minimizes the need for manual intervention, thereby reducing labor costs and the potential for human error. The modular design of the artificial intelligence-based system, incorporating the retrofitting control unit 122, ensures compatibility with both modern and conventional farming equipment, making it accessible and adaptable for a wide range of agricultural setups.

Additionally, the comprehensive data management capabilities of the artificial intelligence-based system, supported by robust databases and knowledge repositories, enable continuous learning and improvement of farming practices. By incorporating the one or more artificial intelligence models and the one or more machine learning models, the artificial intelligence-based system may dynamically update and refine its recommendations based on evolving environmental conditions and the historical data. This adaptability is crucial for addressing the challenges posed by climate change and variable weather patterns.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence-based system for performing one or more actions associated with plant management, comprising:
one or more sensors operatively positioned in a field of plants, wherein the one or more sensors configured to generate sensor data; and
one or more servers comprising:
one or more hardware processors;
a memory unit coupled to the one or more hardware processors, wherein the memory unit comprises a set of computer-readable instructions in form of a plurality of subsystems, configured to be executed by the one or more hardware processors, wherein the plurality of subsystems comprises:
a data-obtaining subsystem configured to obtain at least one of:
the sensor data from the one or more sensors;
weather data, and precipitation data associated with one or more locations of the field of plants through at least one of: a user manual input, on-site weather sensors, satellite-based monitoring, Internet of Things (IoT) weather stations, weather application programming interfaces (APIs), weather forecast models, weather data integration platforms, and one or more communication device applications; and
agronomic variables data from one or more communication devices configured with the artificial intelligence-based system, through one or more user interfaces;
a hydrological modeling subsystem configured with one or more computational models to determine at least one of: interpolate sensor data and extrapolate sensor data, between the one or more sensors based on at least one of: water evaporation rates and agronomic variables data of an associated location of the one or more locations of the field of plants;
a data analysis subsystem configured with the one or more computational models to perform a comparative analysis between the obtained sensor data and pre-defined sensor data stored in a database, based on at least one of the: weather data, precipitation data, agronomic variables data, and at least one of the: interpolate sensor data and extrapolate sensor data, to generate one or more instructions; and
a plant management subsystem configured to autonomously actuate one or more agrarian equipment positioned in the one or more locations of the field of plants for performing the one or more actions associated with plant management, based on the generated one or more instructions.

2. The artificial intelligence-based system of claim 1, wherein the one or more actions comprises at least one of: water management, nutrient application, pest control, weed management, growth monitoring, yield prediction, soil health assessment, crop rotation planning, harvesting scheduling, remote monitoring and diagnostics, and climate adaptation strategies.

3. The artificial intelligence-based system of claim 1, wherein the sensor data comprises at least one of: soil moisture data, soil pH levels, soil health data, soil composition data, soil temperature data, leaf wetness, micronutrient levels, disease detection data, plant canopy temperature, and root zone temperature.

4. The artificial intelligence-based system of claim 1, wherein the agronomic variables data comprises at least one of: flora-type data, growth stage data, and field characteristics data,
the flora-type data comprises at least one of: crop types, plant species, and plant density;
the growth stage data comprises at least one of a: seedling stage, vegetative stage, flowering stage, fruiting stage, and ripening stage; and
the field characteristics data comprises at least one of: soil types, soil compositions, gradient of a field inclinations, field sizes, and drainage characteristics.

5. The artificial intelligence-based system of claim 1, wherein the one or more computational models comprises at least one of: one or more artificial intelligence models, one or more machine learning models, and one or more analytical models,
the one or more artificial intelligence models configured to analyze the pre-defined sensor data obtained in the database for updating required soil moisture levels for the diverse flora-type data in the database with respect to at least one of the: weather data, precipitation data, and agronomic variables data,
the one or more artificial intelligence models comprises at least one of: artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), and fuzzy logic systems;
the one or more machine learning models configured to analyze the sensor data to identify patterns of the soil moisture data and forecast the soil moisture levels for performing the one or more actions associated with plant management based on diverse conditions,
the one or more machine learning models comprises at least one of: linear regression, polynomial regression, the decision trees, random forests, the gradient boosting machines (GBM), the support vector machines (SVM), the K-nearest neighbors (KNN), the Bayesian networks, and clustering models; and
the one or more analytical models configured to determine at least one of the: interpolate sensor data and extrapolate sensor data for performing the one or more actions associated with plant management based on the water evaporation rates,
the one or more analytical models comprises at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, and water budget models.

6. The artificial intelligence-based system of claim 1, wherein the one or more computational models utilized in the hydrological modelling subsystem, is at least one of the: one or more machine learning models and one or more analytical models; and
the one or more computational models utilized in the data analysis subsystem is at least one of the: one or more artificial intelligence models and one or more machine learning models.

7. The artificial intelligence-based system of claim 1, wherein the data analysis subsystem is configured to perform the one or more actions in real-time based on real-time feedback from at least one of the: sensor data, weather data, and precipitation data.

8. The artificial intelligence-based system of claim 1, wherein the one or more instructions comprises at least one of: irrigation schedule data, water amount data, irrigation duration data, irrigation frequency data, zone-specific irrigation data, soil moisture target levels, notifying the micronutrient levels, one or more alerts for manual intervention, one or more fertilization schedule alerts, pest and disease control instructions, pruning schedules, optimal harvest times, crop rotation recommendations, drainage management instructions, one or more water quality monitoring alerts, remote system diagnostics, and one or more irrigation system maintenance alerts.

9. The artificial intelligence-based system of claim 1, wherein the plant management subsystem is configured to autonomously actuate the one or more agrarian equipment through one or more agrarian control modules, for performing the one or more actions of at least one of: the entire plant field, a zone-specific within the plant field, and pattern-specific within the plant field,
the one or more agrarian equipment comprises at least one of: one or more irrigation equipment, one or more soil preparation equipment, one or more planting equipment, one or more crop maintenance tools, one or more harvesting machinery, one or more transport equipment, one or more post-harvest equipment, and one or more pest control equipment.

10. The artificial intelligence-based system of claim 1, wherein the artificial intelligence-based system comprises a manual override subsystem,
the manual override subsystem configured to perform the one or more actions through the user interface associated with the one or more communication devices.

11. The artificial intelligence-based system of claim 1, wherein the artificial intelligence-based system is configured with a retrofitting control unit,
the retrofitting control unit is configured to interface with one or more existing agrarian equipment by employing at least one of a: retrofitting controller, retrofitting adapter, programmable logic controllers (PLCs), electrically controlled valves, and modular sensor interfaces, via one or more communication networks, for performing the one or more actions.

12. An artificial intelligence-based method for performing one or more actions associated with plant management, comprising:
generating, by one or more sensors, sensor data;
obtaining, by one or more servers, at least one of: the sensor data, weather data, precipitation data, and agronomic variables data;
determining, by the one or more servers configured with one or more computational models, at least one of: interpolate sensor data and extrapolate sensor data, between the one or more sensors based on at least one of: water evaporation rates and agronomic variables data of an associated location of the one or more locations of the plant field;
performing, by the one or more servers configured with the one or more computational models, a comparative analysis between the obtained sensor data and pre-defined sensor data stored in a database, based on at least one of the: weather data, precipitation data, agronomic variables data, and at least one of the: interpolate sensor data and extrapolate sensor data to generate one or more instructions; and
actuating, by the one or more servers, one or more agrarian equipment positioned in the one or more locations of the plant field for performing the one or more actions associated with plant management, based on the generated one or more instructions.

13. The artificial intelligence-based method of claim 12, wherein
the sensor data is generated by the one or more sensors operatively positioned in the plant field;
the weather data, and the precipitation data associated with the location of the plant field is obtained through at least one of a: user manual input, on-site weather sensors, satellite-based monitoring, Internet of Things (IoT) weather stations, weather application programming interface (API), weather forecast models, weather data integration platforms, and one or more communication device applications; and
the agronomic variables data is obtained from one or more communication devices configured with the artificial intelligence-based system, through one or more user interfaces.

14. The artificial intelligence-based method of claim 12, wherein
the sensor data comprises at least one of: soil moisture data, soil pH levels, soil health data, soil composition data, soil temperature data, leaf wetness, micronutrient levels, disease detection data, plant canopy temperature, and root zone temperature; and
the agronomic variables data comprises at least one of: flora-type data, growth stage data, and field characteristics data.

15. The artificial intelligence-based method of claim 12, wherein the one or more computational models comprises at least one of: one or more artificial intelligence models, one or more machine learning models, and one or more analytical models,
the one or more artificial intelligence models configured to analyze the pre-defined sensor data obtained in the database for updating required soil moisture levels for the diverse flora-type data in the database with respect to at least one of the: weather data, precipitation data, and agronomic variables data,
the one or more artificial intelligence models comprises at least one of:
artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), and fuzzy logic systems;
the one or more machine learning models configured to analyze the sensor data to identify patterns of the soil moisture data and forecast the soil moisture levels for performing the one or more actions associated with plant management based on diverse conditions,
the one or more machine learning models comprises at least one of: linear regression, polynomial regression, the decision trees, the random forests, the gradient boosting machines (GBM), the support vector machines (SVM), the K-nearest neighbors (KNN), the Bayesian networks, and clustering models; and
the one or more analytical models configured to determine at least one of the: interpolate sensor data and extrapolate sensor data for performing the one or more actions associated with plant management based on the water evaporation rates,
the one or more analytical models comprises at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, and water budget models.

16. The artificial intelligence-based method of claim 12, wherein the one or more instructions comprises at least one of: irrigation schedule data, water amount data, irrigation duration data, irrigation frequency data, zone-specific irrigation data, soil moisture target levels, notifying the micronutrient levels, one or more alerts for manual intervention, one or more fertilization schedule alerts, pest and disease control instructions, pruning schedules, optimal harvest times, crop rotation recommendations, drainage management instructions, one or more water quality monitoring alerts, remote system diagnostics, and one or more irrigation system maintenance alerts.

17. The artificial intelligence-based method of claim 12, wherein the one or more servers is configured to autonomously actuate the one or more agrarian equipment through one or more agrarian control modules, for performing the one or more actions in the at least one of: the entire plant field, a zone-specific within the plant field, and pattern-specific within the plant field,
the one or more agrarian equipment comprises at least one of: one or more irrigation equipment, one or more soil preparation equipment, one or more planting equipment, one or more crop maintenance tools, one or more harvesting machinery, one or more transport equipment, one or more post-harvest equipment, and one or more pest control equipment.

18. The artificial intelligence-based method of claim 12, wherein the artificial intelligence-based method is configured to interface with one or more existing agrarian equipment by employing at least one of a: retrofitting controller, retrofitting adapter, programmable logic controllers (PLCs), electrically controlled valves, and modular sensor interfaces, via one or more communication networks, for performing the one or more actions.

19. A non-transitory computer-readable storage medium having programmable instructions stored therein, that when executed by one or more servers, cause the one or more servers to:
obtaining at least one of: sensor data, weather data, precipitation data, and agronomic variables data;
determining by using one or more computational models at least one of: interpolate sensor data and extrapolate sensor data, between one or more sensors based on at least one of: water evaporation rates and agronomic variables data of an associated location of the one or more locations of the plant field;
performing by using the one or more computational models a comparative analysis between the obtained sensor data and pre-defined sensor data stored in a database, based on at least one of the: weather data, precipitation data, agronomic variables data, and at least one of the: interpolate sensor data and extrapolate sensor data to generate one or more instructions; and
actuating one or more agrarian equipment positioned in the one or more locations of the plant field for performing the one or more actions associated with plant management, based on the generated one or more instructions.

20. The non-transitory computer-readable storage of claim 19, wherein the one or more computational models comprises at least one of: one or more artificial intelligence models, one or more machine learning models, and one or more analytical models,
the one or more artificial intelligence models configured to analyze the pre-defined sensor data obtained in the database for updating required soil moisture levels for the diverse flora-type data in the database with respect to at least one of the: weather data, precipitation data, and agronomic variables data,
the one or more artificial intelligence models comprises at least one of: artificial neural networks (ANN), deep learning models, convolutional neural networks (CNN), recurrent neural networks (RNN), support vector machines (SVM), decision trees, random forests, gradient boosting machines (GBM), Bayesian networks, K-nearest neighbors (KNN), and fuzzy logic systems;
the one or more machine learning models configured to analyze the sensor data to identify patterns of the soil moisture data and forecast the soil moisture levels for performing the one or more actions associated with plant management based on diverse conditions,
the one or more machine learning models comprises at least one of: linear regression, polynomial regression, the decision trees, the random forests, the gradient boosting machines (GBM), the support vector machines (SVM), the K-nearest neighbors (KNN), the Bayesian networks, and clustering models; and
the one or more analytical models configured to determine at least one of the: interpolate sensor data and extrapolate sensor data for performing the one or more actions associated with plant management based on the water evaporation rates,
the one or more analytical models comprises at least one of: linear interpolation models, linear extrapolation models, polynomial interpolation models, polynomial extrapolation models, spline interpolation, inverse distance weighting (IDW), kriging, finite element method (FEM), Richards equation models, soil moisture accounting (SMA) Models, evapotranspiration models, hydrological balance models, van genuchten model, and water budget models.
